(19) United States
(12) Patent Application Publication
(10) Pub. No.: US 2014/0229207 A1
(43) Pub. Date: Aug. 14, 2014

(54) DAMAGE ASSESSMENT OF AN OBJECT

(71) Applicants: Prashanth Swamy, Bangalore (IN); Goutam Yg, Bangalore (IN); M. Girish Chandra, Bangalore (IN); Balamuralidhar P, Bangalore (IN)

(72) Inventors: Prashanth Swamy, Bangalore (IN); Goutam Yg, Bangalore (IN); M. Girish Chandra, Bangalore (IN); Balamuralidhar P, Bangalore (IN)

(73) Assignee: TATA CONSULTANCY SERVICES LIMITED, Mumbai (IN)

(21) Appl. No.: 14/348,450

(22) PCT Filed: Sep. 7, 2012
(86) PCT No.: PCT/IN2012/000596

§ 371 Date: Mar. 28, 2014

(30) Foreign Application Priority Data
Sep. 29, 2011 (IN) 2751/MUM/2011

(51) Int. Cl. G06Q 40/08; G06T 7/00

(52) U.S. Cl. CPC G06Q 40/08; G06T 7/001; G06T 7/0081; G06T 7/0089; G06T 2207/20116; G06T 2207/20164; G06T 2207/30164
USPC 705/4

(57) ABSTRACT

Systems and methods for assessing damage in a damaged object are disclosed. The method comprises receiving visual data of the damaged object by a computing system. The visual data is converted into at least one Multi-Dimensional (MD) representation of the damaged object. The method further comprises identifying a first set of characteristic points in the at least one MD representation of the damaged object. The first set of characteristic points includes at least one subset of characteristic points, and each of the at least one subset of characteristic points substantially corresponds to a portion of the damaged object. The method furthermore comprises determining at least one first set of contour maps of the portion of the damaged object using the at least one MD representation. Using the first set of characteristic points and the at least one first set of contour maps, the damage in the damaged object is assessed.

### TECHNICAL FIELD

The present subject matter described herein, in general, relates to assessing damage in an object and, in particular, relates to assessing damage in the object based on visual data.

### BACKGROUND

Accidents may cause damage to objects, such as vehicles, machines, air planes, and the like. When an object gets damaged due to an accident, the owner of the object may seek damages from an insurance company which has insured the object. For example, when vehicles involved in road accidents generally get damaged, the owner of the vehicle may seek damages from an insurance company which has insured the vehicle. In order to claim damages, an owner of the object may contact the insurance company providing insurance for the object. The insurance company may send an insurance agent to inspect the damaged object. The insurance agent may physically inspect the damaged object to prepare an insurance claim report, which may include severity of damage, approximate cost of repair of the object, etc. Since the number of accidents is increasing day by day, a process involving physical inspection of the damaged objects by insurance agents to prepare insurance claim reports is becoming tedious and time consuming for both the insurance companies and for the object owners.

### SUMMARY

This summary is provided to introduce concepts related to systems and methods for assessing damage in a damaged object and the concepts are further described below in the detailed description. This summary is not intended to identify essential features of the claimed subject matter nor is it intended for use in determining or limiting the scope of the claimed subject matter.

In one implementation, a method for assessing damage in a damaged object is disclosed. The method comprises receiving visual data of the damaged object by a computing system. The visual data is converted into at least one Multi-Dimensional (MD) representation of the damaged object. The method further comprises identifying a first set of characteristic points in the at least one MD representation of the damaged object, wherein the first set of characteristic points comprises at least one subset of characteristic points, and wherein each of the at least one subset of characteristic points substantially corresponds to a portion of the damaged object. The method furthermore comprises determining at least one first set of contour maps of the portion of the damaged object using the at least one MD representation of the damaged object. The method furthermore comprises assessing the damage in the damaged object using the first set of characteristic points and the at least one first set of contour maps.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network implementation of a damage assessment system, in accordance with an embodiment of the present subject matter.

FIG. 2 illustrates a method for automatically extracting frames of interest from a video, in accordance with an embodiment of the present subject matter.

FIG. 3 is a pictorial representation of a method for assessing damage in a vehicle, in accordance with an embodiment of the present subject matter.

FIG. 4 is a pictorial representation of a method for comparing contour maps of a damaged vehicle with contour maps of an undamaged vehicle, in accordance with an embodiment of the present subject matter.

FIG. 5 illustrates a method for automatically assessing damage in a damaged object, in accordance with an embodiment of the present subject matter.

### DETAILED DESCRIPTION

System and method for automatically assessing damage in an object are described herein. The system and the method can be implemented in a variety of computing systems. The computing systems that can implement the described method include, but are not restricted to, mainframe computers, workstations, personal computers, desktop computers, minicomputers, servers, multiprocessor systems, laptops, mobile computing devices, and the like.

In one example, the present method and the system may be used to assess damage caused to an object in an accident. It may be understood that although the object may include a vehicle, an air plane, a machine, a mechanical device, or any other article, the present subject matter may be explained with respect to a vehicle.

In the present example, when a user of a vehicle meets with an accident, the vehicle may get damaged. If the vehicle is insured by an insurance company, the user may seek to claim damages from the insurance company. Since, the number of road accidents is increasing day by day, a process involving insurance agents to physically inspect the damaged vehicles and then prepare insurance claim reports is quite tedious and inconvenient for both the insurance companies and the vehicle owners.

According to an embodiment of the present subject matter, systems and methods for automatically assessing or inspecting the damaged objects and preparing insurance claim reports are provided. In one embodiment, after the vehicle meets with an accident, the user of the vehicle may capture visual data of the damaged vehicle using a digital camera. The visual data may include at least one of images, a video, and an animation of the damaged vehicle. The user may upload or send the visual data to the insurance company. The visual data may be used to create one or more Multi-Dimensional (MD) representations of the damaged vehicle. The multi-dimensional representation may include at least one of 2 dimensional, 3 dimensional, 4 dimensional, or 5 dimensional representation of the damaged vehicle. The MD representation of the damaged vehicle is a collection of characteristic points representing the damaged vehicle in multiple dimensions.

Subsequently, a first set of characteristic points may be identified in the MD representation of the damaged vehicle. The first set of characteristic points provides feature description of the damaged vehicle. In one implementation, a Scale Invariant Feature Transform (SIFT) technique and a Combined Corner and Edge Detector (CCED) technique may be used to identify the first set of characteristic points in the damaged vehicle. Each subset of the first set of characteristic points corresponds to a portion of the damaged vehicle in the MD representations of the damaged vehicle. For example, a first subset of the first set of characteristic points may substantially correspond to a left headlight, a second subset of the first set of characteristic points may substantially correspond to a right headlight, so on and so forth. Therefore, each part or portion of the damaged vehicle will have a unique subset of characteristic points.

Subsequent to the identification of the characteristic points in the MD representations of the damaged vehicle, an active contours technique may be applied on the MD representations of the damaged vehicle. The active contours technique may help in determining a shape of the damaged vehicle. Typically, the active contour technique may apply a mesh on a surface of the damaged vehicle. The mesh may take the shape of the damaged vehicle thereby providing information about dents, protrusions, or any other shape related variation in the damaged vehicle.

Subsequent to the determination of the first set of characteristic points and the shape of the damaged vehicle, the SIFT technique, the CCED technique, and the active contours technique may be applied on an image of a reference vehicle to determine a second set of characteristic points and a shape of the reference vehicle. The reference vehicle is an undamaged vehicle and has the same vehicle specification as that of the damaged vehicle. The second set of characteristic points and the shape of the reference vehicle are compared with the first set of characteristic points and the shape of the damaged vehicle, thereby assessing an extent of damage in the damaged vehicle. Based on the extent of damage, a claim report may be prepared.

Therefore, the system and the method may automatically process the visual data of the damaged vehicle to assess damage, estimate cost of repair, and calculate severity of damage in the vehicle. Subsequently, the system may automatically prepare an insurance claim report including the estimate for cost of repair and the severity of damage. The system determines the extent of damage based on, for example, fuzzy logic, and prepares a claim report automatically, thereby helping the users and the insurance companies to settle the insurance claims in an efficient manner.

Thus, since the damage analysis of the vehicle may be done with zero or minimum human intervention, an agent of the insurance company may not be required to go to an accident site. Additionally, a user may not have to go through the tedious process of claiming damages, thereby making it convenient for the user as well.

While aspects of described systems and methods for assessing damage in an object may be implemented in any number of different computing systems, environments, and/or configurations, the embodiments are described in the context of the following exemplary system.

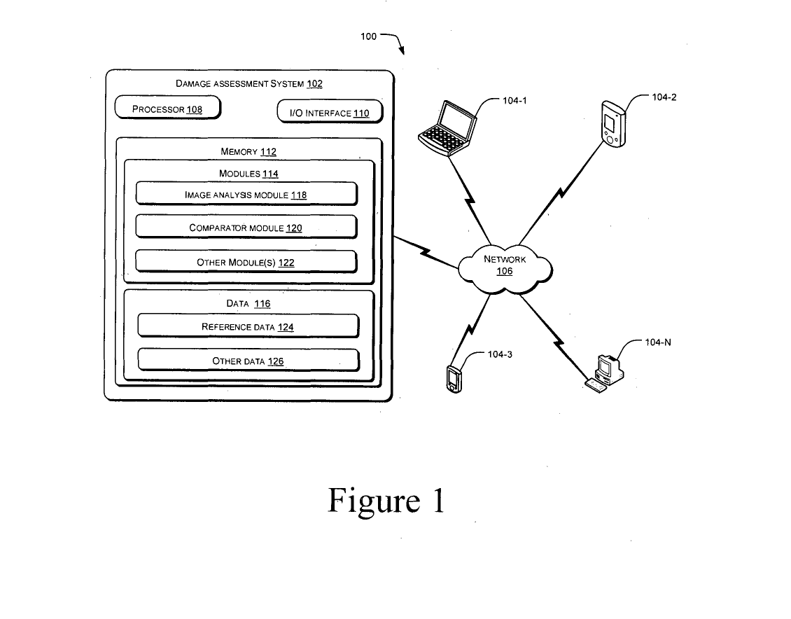

Referring now to FIG. 1, a network implementation 100 of a Damage Assessment System (DAS) 102 for assessing damage in an object is illustrated, in accordance with an embodiment of the present subject matter. Although the object may include a vehicle, an air plane, a machine, a mechanical device, or any other article, the present subject matter may be explained with respect to a vehicle. In one embodiment, the DAS 102 may be configured to assess damage in the object and prepare an insurance claim report of the object for a financial institution such as an insurance company. In one implementation, the DAS 102 may be included within an existing information technology infrastructure of the insurance company. Further, the DAS 102 may be implemented in a variety of computing systems such as a laptop computer, a desktop computer, a notebook, a workstation, a mainframe computer, a server, a network server, and the like. It will be understood that the DAS 102 may be directly accessed by executives of a compliance department of the insurance company or by users through one or more client devices 104 or applications residing on client devices 104. Examples of the client devices 104 may include, but are not limited to, a portable computer 104-1, a personal digital assistant 104-2, a handheld device 104-3, and a workstation 104-N. The client devices 104 are communicatively coupled to the DAS 102 through a network 106 for facilitating one or more users of the objects.

In one implementation, the network 106 may be a wireless network, a wired network or a combination thereof The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the DAS 102 may include at least one processor 108, an I/O interface 110, and a memory 112. The at least one processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the DAS 102 to interact with the client devices 104. Further, the I/O interface 110 may enable the DAS 102 to communicate with other computing devices, such as web servers and external data servers (not shown). The. I/O interface 110 can facilitate multiple communications within a wide variety of networks and protocol types, including wired networks, for example LAN, cable, etc., and wireless networks such as WLAN, cellular, or satellite. The I/O interface 110 may include one or more ports for connecting a number of devices to one another or to another server.

The memory 112 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 112 may include modules 114 and data 116.

The modules 114 include routines, programs, objects, components, data structures, etc., which perform particular tasks or implement particular abstract data types. In one implementation, the modules 114 may include an image analysis module 118, a comparator module 120, and other modules 122. The other modules 122 may include programs or coded instructions that supplement applications and functions of the DAS 102.

The data 116, amongst other things, serves as a repository for storing data processed, received, and generated by one or more of the modules 114. The data 116 may also include reference data 124 and other data 126. The other data 126 includes data generated as a result of the execution of one or more modules in the other module 122.

In one embodiment, an object, such as a vehicle may meet with an accident. The accident may cause damage to the vehicle. A user of the vehicle may wish to claim damages from an insurance company which has insured the vehicle. To claim the damages, the user may capture visual data of the damaged vehicle. The visual data may include at least one of an image and a video of the damaged vehicle. In one implementation, the visual data may be captured using a digital camera. The digital camera may be a built-in digital camera of a mobile phone belonging to the user of the vehicle or may be any other digital camera.

In one implementation, the user may select or indicate the vehicle in the visual data, for example, using the mobile phone to distinguish the vehicle from a background in the visual data. In an example, the user may mark an outline of the vehicle in the visual data, for example in an image, in order to clearly distinguish the outline of the vehicle with respect to the background in the visual data. Subsequent to identification of the vehicle in the visual data, the user may upload or send the visual data to the DAS 102 using the network 106. In one implementation, the user may either use an application installed in one or more of client devices 104 to upload the visual data to the DAS 102 or may use one or more of the clients devices 104 to send the visual data to the DAS 102. However, in another implementation, the user may send or upload the visual data on to the DAS 102 without marking the outline of the vehicle in the visual data. In this implementation, the DAS 102 may automatically distinguish the vehicle from the background in the visual data using techniques, such as, Scale Invariant Feature Transform (SIFT) technique. The SIFT technique may be used to identify an object of interest in an image. In other words, the SIFT technique may be used to distinguish the vehicle from the background in the image.

The SIFT technique is invariant to changes in image scale, noise, illumination, and local geometric distortion to perform reliable recognition of the vehicle in the visual data, such as an image of the vehicle. Although SIFT technique is known in the art; however it's application with respect to the present subject matter may be understood with the following description. A brief description of the SIFT technique is explained as follows. The vehicle images are convolved with Gaussian filters at different scales, and then differences of successive Gaussian-blurred images are taken. Characteristic points are then taken as maxima or minima of the Difference of Gaussians (DoG) that occur at multiple scales. Specifically, a DoG image D(x,y,σ) is given by

D(x, y, σ)=L(x, y, kᵢσ)−L(x, y, kⱼσ),

where L(x,y,kσ) is the convolution of an original image I(x,y) with the Gaussian blur G(x,y,kσ) at scale kσ, i.e.,

L(x, y, kσ)=G(x, y, kσ)*I(x, y)

Hence, a DoG image between scales kᵢσ and kⱼσ is just the difference of the Gaussian-blurred images at scales kᵢσ and kⱼσ for the image of the vehicle. For scale-space extrema detection in the SIFT technique, the vehicle image is first convolved with Gaussian-blurs at different scales. The convolved images are grouped by octave, where an octave corresponds to doubling the value of σ, and the value of kᵢ is selected so that we obtain a fixed number of convolved images per octave. Then the DoG images are taken from adjacent Gaussian-blurred images per octave. Once DoG images have been obtained, characteristic points are identified as local minima/maxima of the DoG images across scales. This is done by comparing each pixel in the DoG images to its eight neighbors at the same scale and nine corresponding neighboring pixels in each of the neighboring scales. If the pixel value is the maximum or minimum among all compared pixels, it is selected as a characteristic point.

Each characteristic point is assigned one or more orientations based on local image gradient directions. This helps in achieving invariance to rotation as the characteristic point descriptor can be represented relative to this orientation. First, the Gaussian-smoothed image L(x,y,σ) at the characteristic point's scale σ is taken so that all computations are performed in a scale-invariant manner. For an image sample L(x,y) at scale σ, the gradient magnitude m(x,y), and orientation θ(x, y), are pre-computed using pixel differences:

$$m ( x , y ) = [ ( L ( x + 1 , y ) - L ( x - 1 , y ) ) 2 + ( L ( x , y + 1 ) - L ( x , y - 1 ) ) 2 ] ( 1 / 2 )$$

$$θ ( x , y ) = tan - 1 ( \frac{L ( x , y + 1 ) - L ( x , y - 1 )}{L ( x + 1 , y ) - L ( x - 1 , y )} )$$

The magnitude and direction calculations for the gradient are done for every pixel in a neighboring region around the characteristic point in the Gaussian-blurred image L. An orientation histogram with 36 bins may be formed, with each bin covering 10 degrees. Each sample in the neighboring window added to a histogram bin is weighted by its gradient magnitude and by a Gaussian-weighted circular window with a that is 1.5 times that of the scale of the characteristic point. For creating a descriptor, in other words a feature vector for each characteristic point, first a set of orientation histograms is created on 4×4 pixel neighborhoods with 8 bins each. These histograms are computed from magnitude and orientation values of samples in a 16×16 region around the characteristic point such that each histogram contains samples from a 4×4 sub-region of the original neighborhood region. The magnitudes are further weighted by a Gaussian function with a equal to one half the width of the descriptor window. The descriptor then becomes a vector of all the values of these histograms. Since there are 4×4=16 histograms, each with 8 bins, the vector has 128 elements. This vector is then normalized to unit length in order to enhance invariance to affine changes in illumination.

In one implementation, apart from the visual data, the user may also send or upload vehicle specification and contextual data onto the DAS 102. The vehicle specification may include dimensions of the vehicle, a model number of the vehicle, a make of the vehicle, and the like. The contextual data may include accelerometer data, gyroscope data, orientation data, time stamp, location, vehicle registration number, insurance policy number, and the like.

In one implementation, images of the vehicle may be received as visual data by the DAS 102. In this implementation, damaged sections of the vehicle may be clearly identified in the images by the user. However, in another implementation, a video of the vehicle may be received as visual data by the DAS 102. In this implementation, the DAS 102, at first, may extract frames of interest from the video. The frames of interest are the frames which clearly show damaged sections of the vehicle. In one implementation, the DAS 102 may use the SIFT technique to extract the frames of interest from the video received.

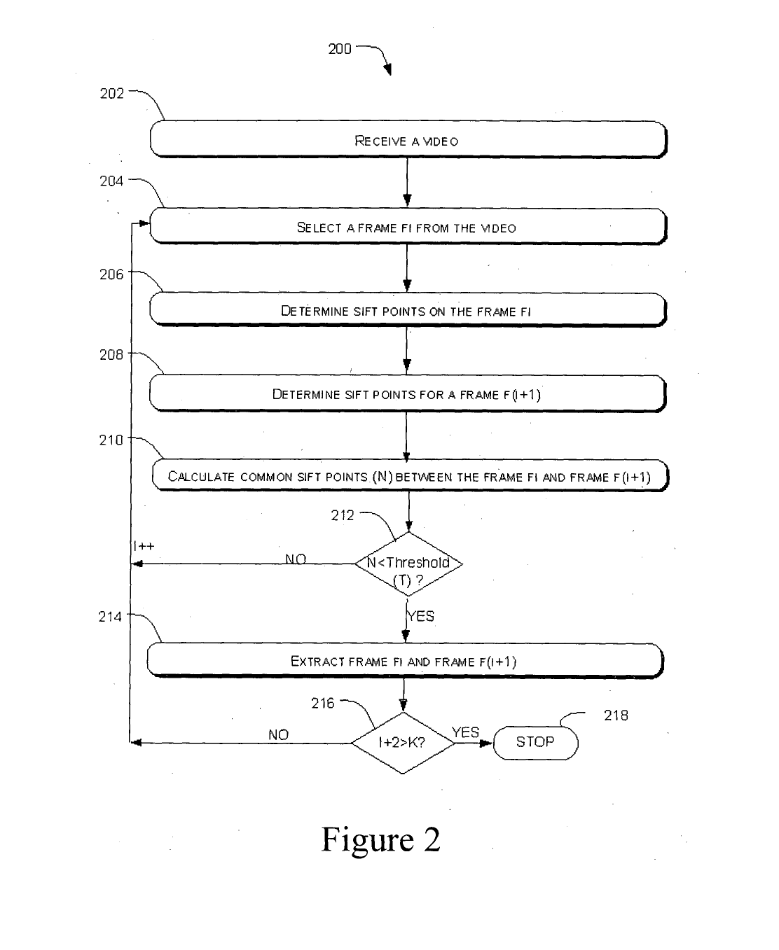

For the purpose of explanation, and not as a limitation, a process of extraction of frames of interest from the video is explained with the help of a following example. Consider that the user captures the vehicle in a video having 2000 frames. In other words, the user may capture the vehicle from left to front to right in 2000 frames. The SIFT technique may determine SIFT points on each of the 2000 frames of the video. Some of the SIFT points will be common on neighboring frames; however the common SIFT points will reduce abruptly when going from one view of a vehicle to another, for example, from left to front of the vehicle. At this point, the common SIFT points between the neighboring frames reduce abruptly and then the neighboring frames are extracted. The extracted frames are referred to as the frames of interest. Similarly, more frames of interest may be extracted. The extracted frames may show the damaged sections of the vehicle. It will be understood, that the process of extraction of frames may not be implemented in case, instead of a video, one or more images are provided. The process of extraction of frames of interest from the video is also explained in detail with reference to description of FIG. 2.

After the frames of interest are extracted from the video, the image analysis module 118 of the DAS 102 may create one or more Multi-Dimensional (MD) representations of the damaged vehicle. Specifically, the image analysis module 118 may convert the images or the frames of interest into one or more MD representations of the damaged vehicle, using techniques, such as the SIFT technique. A MD representation of the damaged vehicle is a collection of characteristic points representing the damaged vehicle in MD. The multi-dimensional representation may include at least one of 2 dimensional, 3 dimensional, 4 dimensional, or 5 dimensional representation of the damaged vehicle.

Subsequently, the image analysis module 118 may identify a first set of characteristic point s in the MD representation s of the damaged vehicle. The first set of characteristic points includes feature descriptors of the damaged vehicle. Specifically, the first set of characteristic points determines structural features of the damaged vehicle and defines the damaged vehicle in terms of feature vectors corresponding to lengths, breadths, heights, curves, shapes, angles, and other structure defining parameters of the damaged vehicle. In one implementation, the image analysis module 118 may use the SIFT technique and a Combined Corner and Edge Detector (CCED) technique to identify the first set of characteristic points in the damaged vehicle. The CCED technique is invariant to rotation, scale, illumination variation, and image noise, and may provide accurate estimation of the first set of characteristic points on the MD representation of the vehicle. The CCED technique may be used to find corner points where edges of the vehicle meet. Further, the CCED technique is based on an autocorrelation function of a signal where the autocorrelation function measures local changes of a signal with patches shifted by a small amount in different directions. The CCED technique is described in brief below.

A basic idea in the CCED technique is to find points where edges of the vehicle meet. In other words, the CCED technique may find points of strong brightness changes in orthogonal directions for the damaged vehicle using the equation given below.

$$E ( u , v ) = {\sum }_{x , y} {w ( x , y ) [ I ( x + u , y + v ) - I ( x , y ) ]}^{2}$$

where, w(x, y) is a window function at point (x, y), I(x+u, y+v) is shifted intensity and I(x, y) is intensity at point (x, y).

For small shifts (u, v), bilinear approximation may be used:

$$E ( u , v ) = [ u , v ] M [ \begin{matrix}u \\ v\end{matrix} ]$$

where M is a 2×2 matrix computed from image derivatives:

$$M = \sum w ( x , y ) [ \begin{matrix}{Ix}^{2} & IxIy \\ IxIy & {Iy}^{2}\end{matrix} ]$$

Measure of corner response is given by:

det M=λ1*λ2

trace M=λ1+λ2

R=det M−k (trace M)²

where λ1, λ2 are eigen values of M.
Choosing the points with large corner response function R (R>threshold) and considering the points of local maxima of R gives the corner points.

In one embodiment, the first set of characteristic points includes at least one subset of characteristic points. Each of the at least one subset of characteristic points of the first set of characteristic points substantially corresponds to a portion or part of the damaged vehicle in the MD representations of the damaged vehicle. For example, a first subset of the first set of characteristic points may substantially correspond to a left headlight, a second subset of the first set of characteristic points may substantially correspond to a right headlight, a third subset of the first set of characteristic points may substantially correspond to a left front door, a fourth subset of the first set of characteristic points may substantially correspond to a front bumper of the vehicle, so on and so forth. Therefore, each part or portion of the damaged vehicle will have a unique subset of characteristic points. Each subset of characteristic points provides specific details about edges, corner points, and other important structural features of a portion to which the subset of characteristic points corresponds.

Subsequent to the identification of the first set of characteristic points in the MD representations of the damaged vehicle, the image analysis module 118 may run an active contour technique on the MD representations of the damaged vehicle. The active contours technique may help in determining a shape of the damaged vehicle by determining at least first set of contour maps of various portions of the damaged vehicle. For example, the active contours technique may apply a mesh on a surface of the damaged vehicle. The mesh may take the shape of the damaged vehicle thereby signifying about dents and protrusions in the damaged vehicle. Further, the active contours technique is an energy minimization technique which gets pulled towards features such as edges, lines with high accuracy in localization. The active contours technique with level set technique give an indication of depth information of the MD representation of the vehicle. The active contours technique is a controlled continuity spline under an influence of image forces and external constraint forces. A spline is a polynomial or set of polynomials used to describe or approximate curves and surfaces of the damaged vehicle in the MD representation. Although the polynomials that make up the spline can be of arbitrary degree, a most commonly used are cubic polynomials. The internal forces serve to impose a piecewise smoothness constraint. The image forces push the active contours technique towards salient image features and subjective contours. The external constraint forces are responsible for putting the active contours technique near a desired local minimum. Using the internal forces, the external forces, and the image forces, the shape of the damaged vehicle may be determined. In one implementation, after the first set of contour maps is determined, the damaged portions may be labeled.

Subsequent to the determination of the first set of characteristic points and the shape of the damaged vehicle, the DAS 102 may apply the SIFT technique, the CCED technique, and the active contours technique on a reference image of a reference vehicle to determine a second set of characteristic points and at least one second set of contour maps for the reference vehicle. The reference image of the reference vehicle may be saved in the reference data 124. The reference image may be identified from the reference data 124 using a 2D barcode that is provided to the DAS 102 by the user along with the visual data. The 2D barcode may include vehicle specification. The vehicle specification may include dimensions of the vehicle, a model number of the vehicle, a make of the vehicle, and the like. Therefore, the 2D barcode may ensure that the damaged vehicle and the reference vehicle have same vehicle specifications.

In one implementation, after the reference image is obtained, the SIFT technique and the CCED technique may be used to generate a MD representation of the reference vehicle from the reference image. The MD representation of the reference image may undergo the SIFT technique and the CCED technique for determination of a second set of characteristic points. The second set of characteristic points may comprise at least one subset of characteristic points. Each of the at least one subset of characteristic points of the second set of characteristic points substantially corresponds to a portion of the reference vehicle.

After the second set of characteristic points of the reference vehicle is determined, the comparator module 120 may compare the second set of characteristic points with the first set of characteristic points. Specifically, the comparator module 120 compares each subset of characteristic points of the second set of characteristic points with each subset of characteristic points of the first set of characteristic points to determine corresponding portions between the damaged vehicle and the reference vehicle. More specifically, since each subset of the first set of characteristic points uniquely identifies a portion of the damaged vehicle; and each subset of the second set of characteristic points uniquely identifies a portion of the reference vehicle, comparing each subset of the first set of characteristic points with each subset of the second set of characteristic points may determine corresponding portions of the damaged vehicle and the reference vehicle. For example, the comparing ensures that a part X of the damaged vehicle and a part X of the reference vehicle are identified so that their contour maps may be compared later. In other words, the comparing ensures that a left front door of the damaged vehicle and a left front door of the reference vehicle are identified and accordingly their contour maps may be compared later.

After the corresponding portions of the damaged vehicle and the reference vehicle are determined, the comparator module 120 may compare the at least one first set of contour maps of a portion of the damaged object with the at least one second set of contour maps of a portion of the reference object, wherein the portion of the damaged object and the portion of the reference object are corresponding portions. After the shape of the damaged vehicle is compared with the shape of the reference vehicle using the first set of contour maps and the second set of contour maps, an extent of damage may be assessed in the damaged vehicle. Specifically, the DAS 102 may use a fuzzy logic to measure the extent of damage in percentage with respect to the reference vehicle. In one example, the fuzzy logic may categorize the extent of damage in four classes, namely, mild, moderate, severe, and fatal. Mild damage may mean 0-20% damage. Moderate damage may mean 20-40% damage. Severe damage may mean 40-70% damage. Fatal damage may mean above 70% damage. In one example, if the extent of damage is around 80%, a manual intervention may be called for. Therefore, the extent of damage may be calculated based upon the comparison of damaged vehicle and the reference vehicle. Based upon the extent of damage, an insurance claim report may be prepared by the DAS 102. Specifically, prices of damaged portions may be fetched and added up to generate an estimate cost of repair.

Referring now to FIG. 2, a method 200 for extraction of frames of interest from a video is shown, in accordance with an embodiment of the present subject matter. In one embodiment, the method 200 is performed by the image analysis module 118. As shown in the method 200, a video is received at block 202. Consider that the video has K frames, where K is an integer. These K frames may have captured the damaged sections of the vehicle. In the present example, the damaged sections may be a left section, a front section, and a right section of the vehicle. While the video is running, the SIFT technique may enable the DAS 102 to select a frame Fᵢ at block 204 from the video, where ‘i’ represents a position of the frame in the video and starts with 1 and ends at K, i.e. 1≧i≦K.

At block 206, the SIFT technique may determine SIFT points on the frame Fᵢ. SIFT points may be used as feature descriptors to describe the frame Fᵢ. At 208, SIFT points are determined for frame F_{(i +1)} as well. At block 210, a number of common SIFT points i.e. N is calculated between the frame F, and the frame F₍ᵢ₊₁₎. At 212, N is compared with a threshold number T. If N>T, then i is incremented by 1 and control shifts to block 204. However, if N<T, then both the frames Fᵢ and F_{(i +1)} are extracted from the video at step 214. This, means that if the common SIFT points between the frames Fᵢ and F₍ᵢ₊₁₎ are too many i.e. N>T, then the frames Fᵢ and F₍ᵢ₊₁₎ are substantially similar and hence the frames Fᵢ and F₍ᵢ₊₁₎ need not be extracted. However, if the Common SIFT points between the frames Fᵢ and F₍ᵢ₊₁₎ are less than a threshold i.e. N<T, then it may be construed that the frames Fᵢ and F₍ᵢ₊₁₎ are substantially dissimilar and hence the frames Fᵢ and F₍ᵢ₊₁₎ need to be extracted. The extracted frames are the frames of interest. Subsequently, at block 216, it is determined whether any frames are left in the video. In other words, it is determined whether i+2 is greater than K. If no, then i is incremented by 1 and the control shifts to step 204. However, if no frames are left in the video, i.e., if i+2 is greater than K, then the process stops at 218.

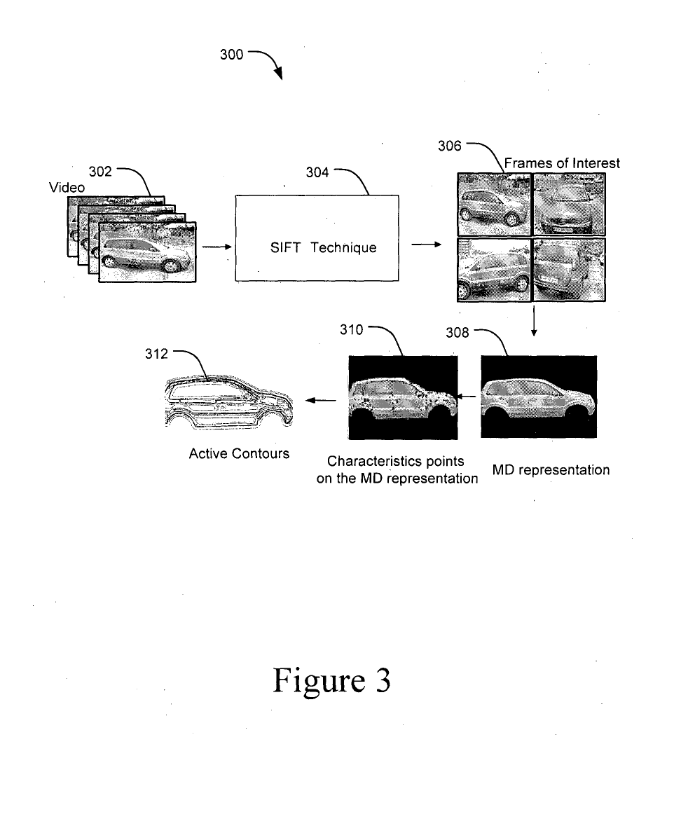

Referring now to FIG. 3, a pictorial representation of a method for assessing damage in a vehicle is shown, in accordance with an embodiment of the present subject matter. In an example, a video 302 of a damaged vehicle is received by the image analysis module 118. The image analysis module 118 may extract frames of interest 306 from the video. For instance, the frames of interest 306 may be extracted using the SIFT technique 304. After the frames of interest 306 are extracted, one or more MD representations 308 may be generated from the frames of interest 306 using the image analysis module 118. Subsequent to generation of the MD representations 308, a first set of characteristic points may be identified by the image analysis module 118, as shown in block 310. In one example, the first set of characteristics points are determined on the MD representation 308 using the SIFT technique and the CCED technique. Each subset of the first set of characteristic points 310 may substantially correspond to a part/portion of the damaged vehicle. After the first set of characteristic points is identified, a first set of contour maps 312 are determined from the MD representation 308 using an Active Contours technique. Similarly, a second set of characteristic points and a second set of contour maps are determined for an undamaged vehicle (not shown).

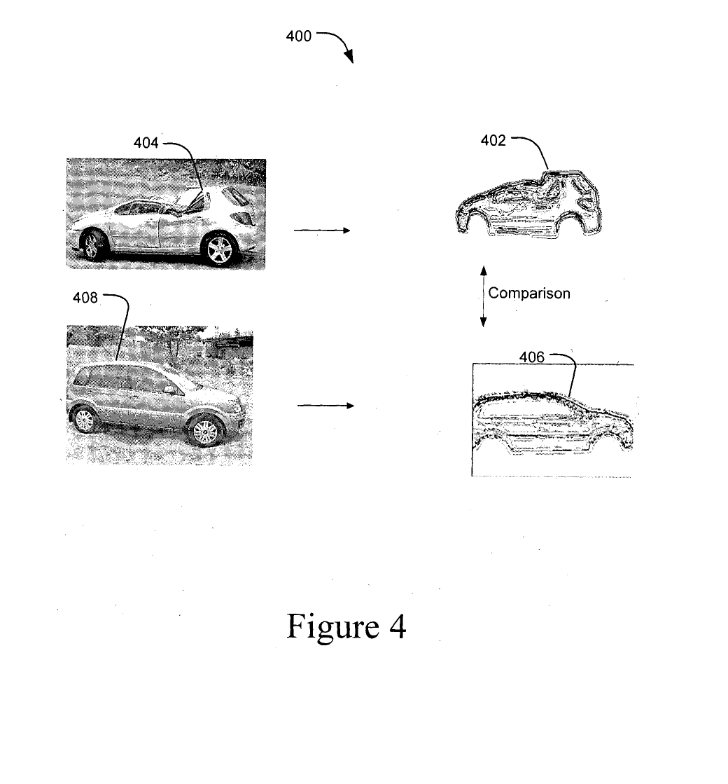

FIG. 4 is a pictorial representation of a method for comparing contour maps of a damaged vehicle with contour maps of an undamaged vehicle, in accordance with an embodiment of the present subject matter. In one example, the method of comparing is performed by the comparator module 120. FIG. 4 shows that the first set of contour maps 402 of portions of the damaged vehicle 404 are compared with the second set contour maps 406 of corresponding portions of the undamaged vehicle 408. The comparison of the first set contour maps 402 with the second set of contour maps 406 may provide difference in shapes of the damaged vehicle with respect to the undamaged vehicle. The difference in shapes may help in assessing an extent of damage in the damaged vehicle.

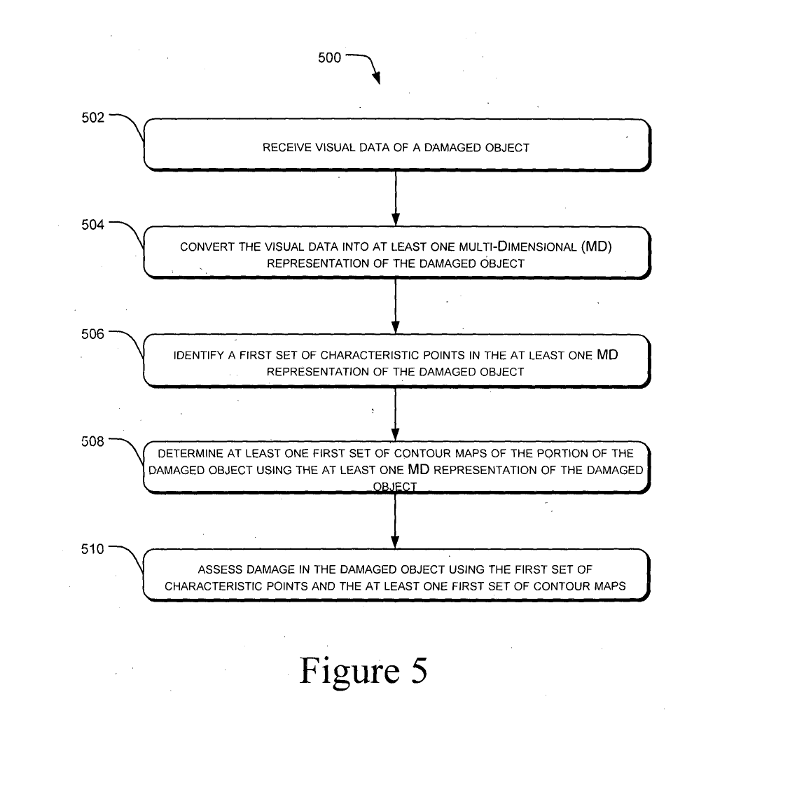

Referring now to FIG. 5, a method 500 for automatically assessing damage in a damaged object is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented in the above described DAS 102.

At block 502, visual data of a damaged object is received. In an implementation, the visual data is provided by a user of the damaged vehicle. In one example, the visual data is received by the image analysis module 118. The visual data may be in the form of one or more images or a video.

At block 504, the visual data is converted into at least one Multi-Dimensional (MD) representation of the damaged object. The visual data may be converted into the MD representation using the SIFT technique and the CCED technique by the image analysis module 118.

At block 506, a first set of characteristic points in the at least one MD representation of the damaged object is identified. The first set of characteristic points includes at least one subset of characteristic points. Each of the at least one subset of characteristic points substantially corresponds to a portion of the damaged object. The first set of characteristic points may be identified using the SIFT technique and the CCED technique. In one example, the first set of characteristic points is determined by the image analysis module 118.

At block 508, at least one first set of contour maps of the portion of the damaged object is determined using the at least one MD representation of the damaged object. The first set of contour maps is determined using the Active Contour technique. In one example, the first set of contour maps is determined using the image analysis module 118.

At block 510, an extent of damage is assessed in the damaged object using the first set of characteristic points and the at least one first set of contour maps. In one example, the damage is assessed using the comparator module 120. The comparator module 120 is configured to compare each subset of characteristic points of the first set of characteristic points with each subset of characteristic points of the second set of characteristic points to determine corresponding portions between the damaged object and the reference object. Subsequently, the comparator module 120 compares the at least one first set of contour maps of the portion of the damaged object with the at least one second set of contour maps of the corresponding portion of the reference object to assess the damage.

The DAS 102 may automatically process the visual data of the damaged object to assess damage and provide a claim report indicative of cost of repair, severity of damage in the object, etc. Subsequently, the DAS 102 may automatically prepare an insurance claim report including the estimate cost of repair and the severity of damage, thereby assisting insurance agents and users.

Although implementations for methods and systems for assessing damage in an object have been described in language specific to structural features and/or methods, it is to be understood that the appended claims are not necessarily limited to the specific features or methods described. Rather, the specific features and methods are disclosed as examples of implementations for automatically assessing damage in the object.

1. A computer implemented method for assessing damage in a damaged object, the method comprising:
receiving, by a processor, visual data of the damaged object by a computing system;
converting, by the processor, the visual data into at least one Multi-Dimensional (MD) representation of the damaged object;
identifying, by the processor, a first set of characteristic points in the at least one MD representation of the damaged object, wherein the first set of characteristic points comprises at least one subset of characteristic points, and wherein each of the at least one subset of characteristic points substantially corresponds to a portion of the damaged object;
determining, by the processor, at least one first set of contour maps of the portion of the damaged object using the at least one MD representation of the damaged object; and
assessing, by the processor, the damage in the damaged object using the first set of characteristic points and the at least one first set of contour maps.

2. The method of claim 1, further comprising:
identifying, by the processor, a second set of characteristic points in an image of a reference object, the reference object being an undamaged object, wherein the second set of characteristic points comprises at least one subset of characteristic points, and wherein each of the at least one subset of characteristic points of the second set of characteristic points substantially corresponds to a portion of the reference object; and
determining, by the processor, at least one second set of contour maps of the portion of the reference object using the image of the reference object.

3. The method of claim 2, wherein assessing the damage comprising:
comparing each subset of characteristic points of the first set of characteristic points with each subset of characteristic points of the second set of characteristic points to determine corresponding portions between the damaged object and the reference object; and
comparing the at least one first set of contour maps of the portion of the damaged object with the at least one second set of contour maps of the portion of the reference object, wherein the portion of the damaged object and the portion of the reference object are corresponding portions.

4. The method of claim 1, further comprising assessing the damage in the damaged vehicle based on fuzzy logic.

5. The method of claim 1, wherein the visual data comprises at least one of a video, at least one image, and an animation of the damaged object.

6. The method of claim 5, further comprising extracting frames of interest from the video using a SIFT technique.

7. A Damage Assessment System (DAS) for assessing damage in a damaged object, the DAS comprising:
a processor; and
a memory coupled to the processor, the memory comprising an image analysis module configured to
receive visual data of the damaged object;
convert the visual data into at least one Multi-Dimensional (MD) representation of the damaged object; and
identify a first set of characteristic points in the at least one MD representation of the damaged object, wherein the first set of characteristic points comprises at least one subset of characteristic points, and wherein each of the at least one subset of characteristic points substantially corresponds to a portion of the damaged object; and
a comparator module configured to assess the damage in the damaged object based in part on the first set of characteristic points.

8. The DAS of claim 7, wherein the image analysis module is further configured to determine at least one first set of contour maps of the portion of the damaged object using the at least one MD representation of the damaged object.

9. The DAS of claim 7, wherein the image analysis module is further configured to:
identify a second set of characteristic points in an image of a reference object, the reference object being an undamaged object, wherein the second set of characteristic points comprises at least one subset of characteristic points, and wherein each of the at least one subset of characteristic points of the second set of characteristic points substantially corresponds to a portion of the reference object; and
determine at least one second set of contour maps of the portion of the reference object using the image of the reference object.

10. The DAS of claim 9, wherein the comparator module is configured to assess the damage by:
comparing each subset of characteristic points of the first set of characteristic points with each subset of characteristic points of the second set of characteristic points to determine corresponding portions between the damaged object and the reference object; and
comparing the at least one first set of contour maps of the portion of the damaged object with the at least one second set of contour maps of the portion of the reference object, wherein the portion of the damaged object and the portion of the reference object are corresponding portions.

11. The DAS of claim 9, wherein the first set of characteristic points and the second set of characteristic points are identified using at least one of a Scale Invariant Feature Transform (SIFT) technique and a Combined Corner and Edge Detector (CCED) technique.

12. The DAS of claim 7, wherein the visual data comprises at least one of a video, at least one image, and an animation of the damaged object.

13. The DAS of claim 12, further comprising extracting frames of interest from the video using a SIFT technique.

14. A non-transitory computer-readable medium having embodied thereon a computer program for executing a method for assessing damage in a damaged object, the method comprising:
receiving visual data of the damaged object;
converting the visual data into at least one Multi-Dimensional (MD) representation of the damaged object;
identifying a first set of characteristic points in the at least one MD representation of the damaged object, wherein the first set of characteristic points comprises at least one subset of characteristic points, and wherein each of the at least one subset of characteristic points substantially corresponds to a portion of the damaged object; and
assessing the damage in the damaged object using the first set of characteristic points.

15. The non-transitory computer-readable medium of claim 14, further comprising:
identifying, a second set of characteristic points in an image of a reference object, the reference object being an undamaged object, wherein the second set of characteristic points comprises at least one subset of characteristic points, and wherein each of the at least one subset of characteristic points of the second set of characteristic points substantially corresponds to a portion of the reference object; and
determining at least one second set of contour maps of the portion of the reference object using the image of the reference object.

16. The non-transitory computer-readable medium of claim 15, wherein assessing the damage comprises:
comparing each subset of characteristic points of the first set of characteristic points with each subset of characteristic points of the second set of characteristic points to determine corresponding portions between the damaged object and the reference object; and
comparing the at least one first set of contour maps of the portion of the damaged object with the at least one second set of contour maps of the portion of the reference object, wherein the portion of the damaged object and the portion of the reference object are corresponding portions.

17. The non-transitory computer-readable medium of claim 15, wherein the first set of characteristic points and the second set of characteristic points are identified using at least one of a Scale Invariant Feature Transform (SIFT) technique and a Combined Corner and Edge Detector (CCED) technique.
